(19) United States
(12) Patent Application Publication
(10) Pub. No.: US 2004/0017801 A1
(43) Pub. Date: Jan. 29, 2004

(54) Method for adapting the OSPF routing protocol to radio networks

(76) Inventors: David Jacquemin, Paris (FR); Franck Schmitt, Meaux (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/421,941

(22) Filed: Apr. 24, 2003

(30) Foreign Application Priority Data
Apr. 30, 2002 (FR) 02 05448

(51) Int. Cl. H04L 12/66

(52) U.S. Cl. 370/352; 370/254

(57) ABSTRACT

Method for adapting the OSPF routing protocol to radio networks A method for routing messages among several radio networks, a radio network comprising at least one or more routers and one designated router (RD), each router comprising a database. The method comprises at least the following steps: at the level of the majority of radio networks, each router sends a request Rr to the designated router (RD) of the radio network; the designated router (RD) responds by sending the contents of its database to all or to the majority of the routers; a router of the radio networks, having received the contents of the database, sends a Hello message in order to search for its different neighbors, each router, knowing its neighbors, sends all the other routers of the network the contents of its database in order to synchronize all its neighbors.

### BACKGROUND OF THE INVENTION

1. Field of the Invention

The invention relates especially to a method for adapting the OSPF (Open Shortest Path First) routing protocol to the specific features of low bit rate or VHF (Very High Frequency) radio networks.

Here below in the description, the proposed routing protocol is called the CBLS (Constraint Base Link State) protocol.

It is used especially in broadcasting networks. It implements the example of the multicast mode to transmit routing information through a network.

2. Description of the Prior Art

There are known ways of using the OSPF in a large or very large dynamic, multiple-access path IP (Internet Protocol) interconnection network.

However, the performance of this protocol becomes inadequate in terms of convergence and network load when it is used on an interconnection of radio networks working at low bit rate.

The object of the invention relates especially to a routing protocol known as the CBLS protocol, compatible with the OSPF protocol and capable of working in a VHF network. It uses for example the multicast mode to send routing information through a network.

### SUMMARY OF THE INVENTION

The invention relates to a method for routing messages among several radio networks, a radio network comprising at least one or more routers and one designated router, each router comprising a database, wherein the method comprises at least the following steps:

at the level of the majority of radio networks, each router sends a request Rr to the designated router of the radio network,

the designated router responds by sending the contents of its database to all or to the majority of the routers of the radio network,

a router of the radio networks, having received the contents of the database, sends a Hello message in order to search for its different neighbors,

each router, knowing its neighbors, sends all the other routers of the network the contents of its database in order to synchronize all its neighbors.

The radio network is, for example, an NBMA broadcasting type of network or, again, a multicast type of network.

The present invention has especially the following advantages:

it is compatible with the OSPF routing protocol and notably improves the performance of this protocol on the radio channel,

it limits the quantity of information to be transmitted on the radio networks, for example to reduce the load on the network,

it reduces the convergence time by accelerating the critical phases of the OSPF protocol.

### BRIEF DESCRIPTION OF THE DRAWINGS

Other features and advantages of the routing method and associated router according to the invention shall appear more clearly from the following description, given by way of an illustration that in no way restricts the scope of the invention and the appended figures of which:

FIG. 1 shows different representations of an interface,

FIGS. 2A, 2B and 2C exemplify information exchanges in a system according to the invention,

FIGS. 3A and 3B show the mechanisms of synchronization of the databases for the OSPF protocol and for the CBLS protocol according to the invention,

FIGS. 4A and 4B show the flooding mechanism in the case of the OSPF protocol and the CBLS protocol according to the invention.

### MORE DETAILED DESCRIPTION

The following description, given by way of an illustration that in no way restricts the scope of the invention, relates to a method for the routing of messages within a set of radio networks.

The Link State Database

This database describes the topology of the autonomous system SA in the form of an oriented graph, with the routers and the networks at the vertex, and the unicast links in an arc. Each input in the base LSA (link state advertisement) describes the neighborhood of a router. This neighborhood depends, for example, on the type of network to which the interface of the router is connected and the number of routers connected to this interface.

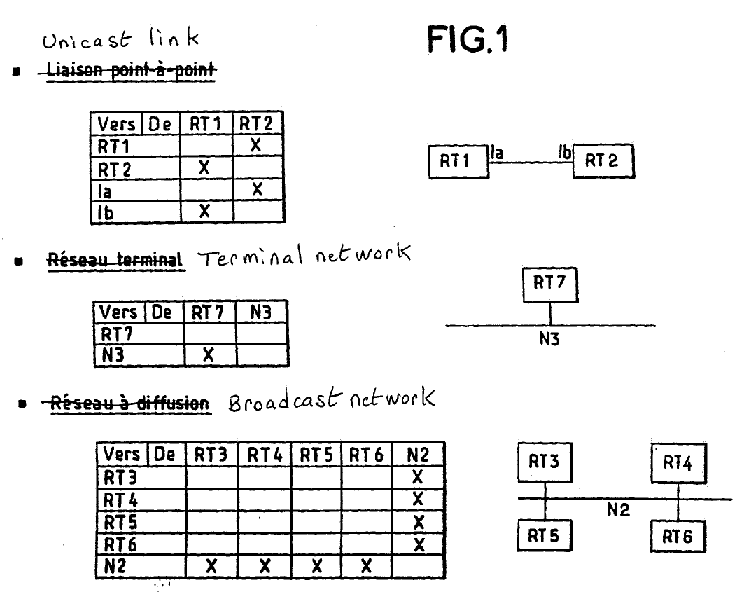

The CBLS protocol according to the invention enables three exemplary representations for one interface (the reference X in the tables of FIG. 1 represents the distance associated with the link). Rti designates a router. The CBLS protocol according to the invention integrates them into its database as follows:

the hosts are represented as terminal networks,

1the networks that have no broadcasting capacity and have all their routers directly interconnected are modeled as broadcasting networks,

the networks that have no broadcasting capacity have routers which are not all directly interconnected are modeled by unicast networks.

Each network of the graph has an associated IP address and a mask. For broadcasting networks or networks modeled as such, a designated router (RD) is elected to take charge of the routing information exchanges for the network.

The database used in the method according to the invention is identical or substantially identical to that of the OSPF protocol. This has the advantage especially of providing compatibility between the two protocols.

Information External to the SA (Autonomous System)

When the shortest path tree has been created, the external routing information is examined. The process which implements the method for computing the shortest path tree consults the information external to the protocol in order to be able to take this information into account. This information comes, for example, from an external routing protocol or again it is configured statically. This information is classified according to the type of metric used: if the metric is that of the CBLS type, then this information is type 1 information. If not it is type 2 information. During the inter-SA (autonomous system) routing, the routes associated with a type 1 metric are always preferred to the routes associated with a type 2 metric.

The CBLS Zones

The CBLS protocol according to the invention defines the different zones inside an SA.

One zone corresponds, for example, to a contiguous group of networks and hosts. The zone has its own link state database and does not know the entire topology of the SA. The detailed topology of a zone is invisible to the rest of the SA. Thus, inside an SA, the routers no longer all have the same database. The subdivision into zones introduces an intra-zone routing and an inter-zone routing:

For the intra-zone routing, only the information internal to the zone is used,

For the intra-zone routing, information external to the zone is used. The inter-zone routers exchange information on the composition of the different zones and propagate this information inside their respective zones.

The different zones are arranged, for example, in a star configuration. There is a central zone called a backbone zone, to which all the other zones are connected. This backbone zone contains for example all the inter-zone routers. Its task especially is to carry out the inter-zone routing and propagate information on one zone to the other zones of the SA. When an inter-zone router receives information coming from another zone, it broadcasts this information inside the zones to which it is connected.

This subdivision into zones and into SAs makes it possible especially to distinguish four kinds of router according to their location:

1. Internal routers: these are routers connected to a single zone. An internal router has only one database

2. Inter-zone routers: these are the routers connected to several zones. They have one database per zone. An inter-zone router summarizes the topological information of the zones to which it is connected to transmit this information to the backbone zone.

3. Backbone routers: these are the routers that have an interface connected to the backbone. All the inter-zone routers are backbone routers.

4. External routers: these are the routers that are connected to another SA. This classification is independent of the other three.

To enable efficient management of the routing, the subdivision into zones is associated with a mask management of the sub-networks. Each route has an associated mask that authorizes the aggregation of several groups of addresses for only one route.

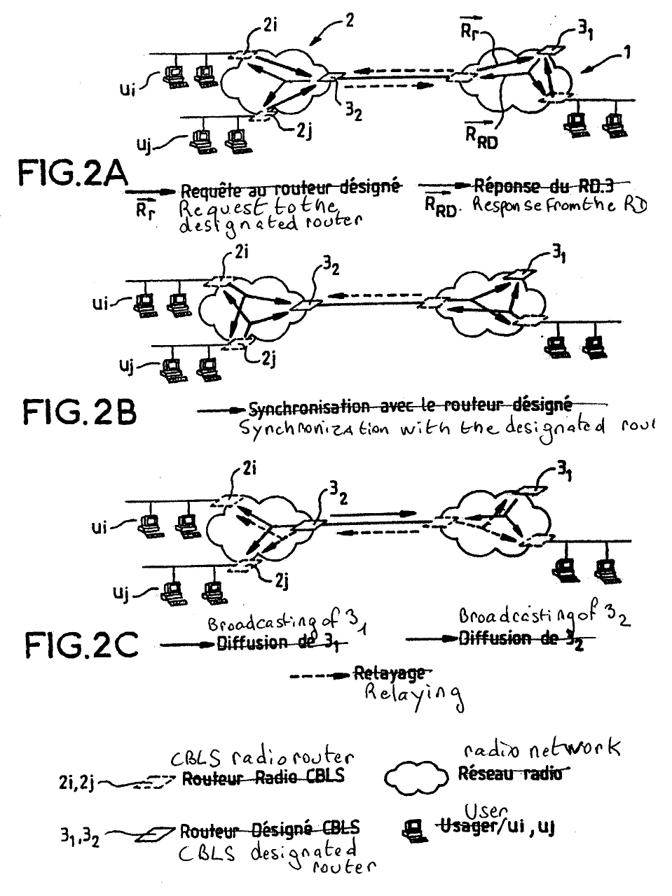

FIGS. 2A, 2B and 2C give a schematic view of an exemplary information exchange between two radio networks.

A radio network 1 comprises for example two routers 2i, 2j to which several users ui, uj, as well as a designated router (RD) referenced 3₁ are connected. The figure indicates a second radio 2 also comprising a router designated 3₂, two routers 2i, 2j connected to users.

The method executes for example the following steps:

at each network, for example, each of the routers 2i, 2j, sends a request designated by the arrow Rr to the designated router (RD) 3₁, 3₂. This router centralizes the requests before responding by sending the contents of its database to all the routers, as indicated by the arrow R_{RD} in FIG. 2A,

after the reception of the message from the designated router 3₁, 3₂: each router of the network 2i, 2j multicasts the contents of the database (i.e. sends these contents in every direction) in order to synchronies all its neighbors, FIG. 2B,

a router (2i, 2j) of the radio network that has received the contents of the database, sends a message Hello in order to look for its different neighbors. This message Hello is, for example, broadcast periodically.

After the local synchronization, each designated router 3₁, 3₂ of a radio network 1 and 2 respectively broadcasts the local information on its network, to the other networks, FIG. 2C. This information is relayed throughout the network. The exchanges are done between the routers for example. The network depends on the configuration implemented with the following boundaries:

if no zone is set up, the network includes the entire SA.

If the zones are defined, the broadcasting differs according to the type of LSA. It may be limited to the zone of membership of the router or else to the SA.

The arrows indicated in dashes in the figure correspond to the relaying.

The CBLS protocol implemented in the method according to the invention comprises for example the steps described here below.

In a first step, when the operation is started, a router initializes the structures needed to implement the protocol. These structures are, for example, those used to load the link state database, information coming from another routing protocol, routing tables, static configuration information. The router then waits for its interfaces with its different neighbors to be put into operation. Generally, each physical link of the router has one or more interfaces associated with it, according to the rules known to those skilled in the art.

At a second stage, a router 2i, 2j, uses for example the Hello protocol to know its different neighbors. A router of a network therefore sends Hello messages to all its neighbors who can be directly contacted in one IP leap and, in return, receives the Hello messages from its neighbors. If the router is connected to a radio network and to an Ethernet network, then its neighbors are all the routers that can be directly contacted through the radio network and through the Ethernet network. On the broadcasting networks and the unicast links, the router detects its neighbors, for example dynamically, by sending Hello messages to the multicast address All OSPF/Routers. On the other networks, a manual configuration is used, for example, to enable this discovery. For the broadcasting networks, the Hello protocol also enables the election of the designated router, RD or 3i.

Once the step of discovering the neighbors is terminated, a router of the network tries to establish relationships of adjacency with its new neighbors. The databases of the routers and a part of its neighbors, in this case its neighbors that are adjacent to it, are then synchronized between pairs of adjacent routers. The relationships of adjacency are used especially in the protocol broadcasting process to reduce the flow of information through the network. For a broadcasting network, it is the designated router that determines the different relationships of adjacency.

A router periodically sends, for example, Hello messages to keep its connectivity with its neighbors. It also periodically sends the state of its database to the other routers of the zone through LSAs. These messages are also broadcast when the state of the database of the router is changed. The LSAs are, for example, broadcast through the CBLS zone to which the router belongs by means of a broadcasting algorithm which ensures that all the routers of the zone have the same database. Once the database is updated, the routers compute the shortest path tree and then fill their respective routing tables.

Inter-Zone Routing

An inter-zone router summarizes the topology of the zones to which it is connected except for the backbone zone. This summary is then transmitted to the backbone which broadcasts it to the other inter-zone routers of the SA. Each inter-zone router therefore receives messages from all the other inter-zone routers of the SA. An inter-zone router therefore has information on the full topology of the backbone and a summary of the topology of the other zones. From this information on topology, the routers compute the paths for all the inter-zone destinations. This information enables each internal router to route the packets intended for the other zones.

Inter-SA Routing

Routers with information on the other autonomous systems can broadcast this information through the SAs. This information, obtained either statically or through an EPG (Exterior Gateway Protocol) is broadcast as such through the SA. In this exemplary embodiment, the networks shown form part of the same SA.

In order that this information may be used on the routers of the SA, knowledge of the external routers is needed. This is why the inter-zone routers also broadcast the location of the external routers.

The Messages

In order to function, the protocol implemented in the method according to the invention uses, for example, four types of message. These messages are sent directly through IP for example. It is also possible to use the IP fragmentation. All the CBLS messages share, for example, a common 20-byte header.

The four types of messages may be the following:

| Type | Name | Function |
|---|---|---|
| 1 | Hello | Discovery of the neighbors and |
| | | maintenance of connectivity |
| 2 | Link State Request | Request for changing the |
| | | database |
| 3 | Link State Update | Database update |
| 4 | Link State Ack | Acknowledgment of an update |

The Hello messages are used at the time of discovery of the neighbors and at the election of the RD (designated router). They also serve to maintain the state of connectivity between the neighbors.

The Link State Request messages are used during the synchronization of the databases between two adjacent routers.

The Link State Update and Link State Ack messages are used to implement the reliable flooding process described here below.

The Hello Protocol

This protocol is used in the step of the discovery of the neighbors, the maintenance of relationships among neighbors, the ensuring of the bidirectional nature of the links and the election of the designated router. A Hello message contains, for example:

The list of the neighbors whose router has the knowledge to enable the bidirectional nature of the connection to be judged,

The priority of the router needed for the election of the designated router,

The identifier of the designated router and of the standby router to which the router is attached,

The various constants of the CBLS protocol according to the invention. These constants are, for example, the following: Hello Interval, Router Dead Interval, Retransmission Interval, Sequence Interval, Request Interval.

To ensure connectivity between the members of the network, the Hello messages are sent periodically, for example on all the output interfaces of the router.

If the router does not receive any Hello message from one of its neighbors during a <<Router Dead Interval>>, then it decides that the neighbor in question is no longer part of the network.

If a router does not receive any Hello message from one of its neighbors during a <<Router Dead Interval>>, then it decides that the neighbor in question no longer forms part of the network.

The Hello protocol works differently, depending on the type of the network, for example:

For a broadcasting network, the multicast mode is used to send the Hello messages. This enables the automatic discovery of the neighbors and the election of the designated router.

For an NBMA (Non-Broadcast Multi-Access) network, a manual configuration is implemented for the discovery of the neighbors and the election of the designated router. Each router of the network, which is a potential candidate for election, possesses, for example, the list of all the other routers attached to the network. These routers then send Hello messages to all the other candidate routers in order to prompt the election. When the designated router is elected, it sends a Hello message to all the other routers of the networks to indicate the end of the election process.

For a multicast network: a router sends a Hello message to all the other routers with which it can communicate. The neighbors can be discovered dynamically by means of a reverse ARP (Address Resolution Protocol) type protocol or by configuration.

The Synchronization of the Database

A link state routing protocol requires the synchronization of the databases of all the routers. Unlike the OSPF in which the synchronization is done in unicast mode, most of the routing information exchanges for the CBLS protocol according to the invention are carried out by using the multicast mode.

After the discovery of the neighbors and the election of the designated router, each router (apart from the designated router) sends an LS Request message, in unicast mode, to the designated router. This message is designed to initialize the exchange of the databases by forcing the designated router to send the contents of the databases. If no response from the designated router has arrived after a waiting period corresponding to a Retransmission Interval, then the new LS Request message is sent to the designated router.

When the first LS Request message is received, the designated router waits during a Request Interval in which it ignores all the other LS Request messages. When this interval is over, the designated router broadcasts the contents of its database to all the routers of the network by sending an LS Update message to the address AllOspfRouter.

Each router, upon receiving the message from the designated router (corresponding to the contents of its database), compares the information contained in the message with the information contained in its database and sends an LS Update in multicast mode. The designated router acknowledges this message. To synchronies the routers of the network, each router sends an LS Update message in multicast mode to the AllOspfRouter address containing the information existing in the database and not present in the message. Then, the router includes the information contained in the message in its database. The LS Update message thus sent is, for example, explicitly acknowledged by the designated router by means of a message LS Ack. If the acknowledgement has not reached the router after a Retransmission Interval than the message is retransmitted.

When the designated router receives an LS Update, it sends the LS Ack message to the sender of the message. This message'serves as an acknowledgement. Since the designated router is at the center of the synchronization process, it acknowledges the LS Update messages in order to have the database as up-to-date as possible.

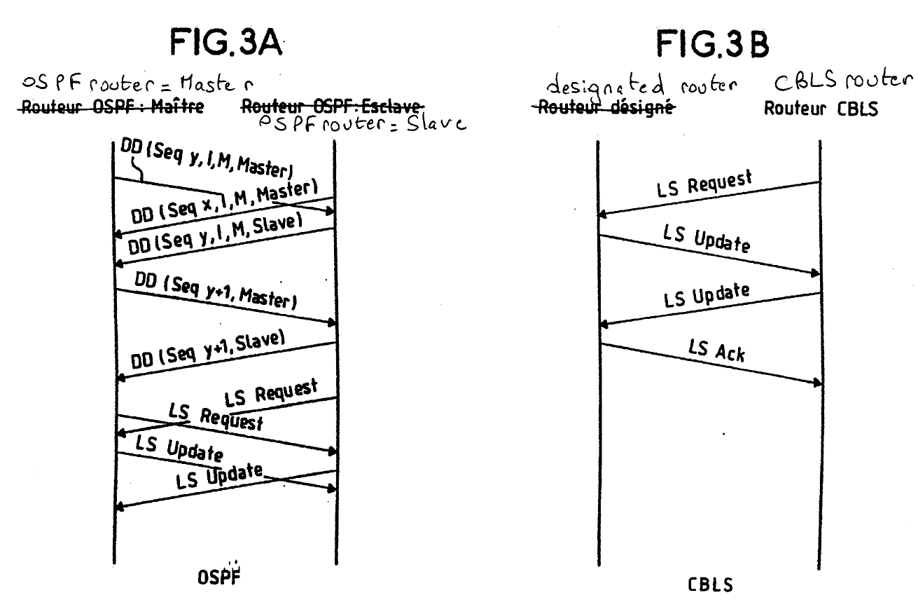

FIGS. 3A and 3B respectively summaries the synchronization messages for the databases in the case of the OSPF protocol and for the CBLS protocol according to the invention.

It will be noted that the number of messages exchanged during the CBLS is appreciably smaller than in the case of the OSPF. In this way, the protocol of the invention contributes to reducing the number of accesses to the radio channel. This is a plus factor in terms of performance.

Furthermore, the use of the multicast mode for all the LS Update messages limits the presence of redundant information on the network. In the case of the OSPF protocol, since the synchronization is a mechanism that uses only the multicast mode, many pieces of information are sent several times on the network, thus reducing the efficiency of the protocol.

The Designated Router

The designated router in a radio network has especially the following roles:

it is the source of the routing messages (Link State Update messages) which list the topology of the network for which it is the designated router,

it is the reference router in the synchronization process,

it is the only router of the network whose database is continually up-to-date,

it is the only router that acknowledges the messages.

It thus plays a role in the essential phases of the CBLS protocol according to the invention.

Link State Advertisement (LSA)

The LSAs are entities that describe the state of the links of the topology of an SA in the database. There are four types of LSA:

1. Router LSAs: they describe the state of the different interfaces of the router,

2. Network LSAs: they describe the set of routers attached to a network;

3. Summary LSAs: they describe the inter-zone routes and enables the aggregation of addresses at the inter-zone router. There are, for example, two types of routers. The first routers summaries the routes whose destinations are external to the SA. The second routers summaries the routes toward the inter-SA routers.

4. AS-External LSAs: they describe the routes whose destinations are external to the SA.

All the LSAs possess an identical header which contains, among others, the following fields:

LS age; this is the age of the LSA expressed in seconds. This value is implemented by the transmission time, at each transmission, and the time of stay in a router,

LS sequence number: this number is used to identify the old LSAs and the doubles.

An LSA is added to the database of a router when:

it is received during the operation of the flooding mechanism,

it is generated by the router itself,

An LSA is eliminated from the database of a router when:

it is replaced by a more recent LSA received during the operation of the flooding mechanism,

it is replaced by a more recent LSA generated by the router itself,

it exceeds the maximum age.

For each interface, each router maintains the list of the different LSAs to be sent to the different neighbors.

Each router can be the source of one or more LSAs. Each router creates example a Router LSA to describe each of its interfaces, for example the physical characteristics of the statically configured interface as well as the different variables of the protocol applied to this interface. The designated router creates a Network LSA for each network for which it is the designated router. An inter-zone router creates a Summary SA for each zone to which belongs. An inter-SA router creates an AS-External LSA for each SA.

Certain events may give rise to the creation of the new LSA, for example:

1. The age of an LSA created by the router reaches the refresh value. In this case, a new instance of the LSA is created even if no change has appeared. This mechanism improves the robustness of the protocol,

2. The state of an interface changes. A new instance of the Router LSA may be created,

3. The router designates a network to which the changed router is attached. A new router LSA is then created. Furthermore, if the router is the new designated router, then it creates a Network LSA router. If the router is the old designated router, then all the Network LSAs created by this router are eliminated,

4. The state of a neighbor changes. A new instance of the Router LSA is created for example.

For the inter-zone routers, the following events may appear:

5. An inter-zone router is created, modified or eliminated in the routing table. The router creates a Summary LSA for this router in each zone to which it is attached,

6. An inter-zone router is created, modified or eliminated in the routing table. The router creates a Summary LSA for this router in the zone to which it is attached, except the backbone zone,

7. The router belongs to a new zone. The router must create a new Summary LSA which summarizes its routing table for the new zone,

8. The modification of a virtual link causes for example the creation of a new LSA router for the transit network

For the inter-SA routers,

9. An external router obtained by an EGP is modified. The new instance of the AS-External LSA may be created,

10. The router stops being an inter-SA router. The AS-External LSAs are then eliminated.

The Flooding Process

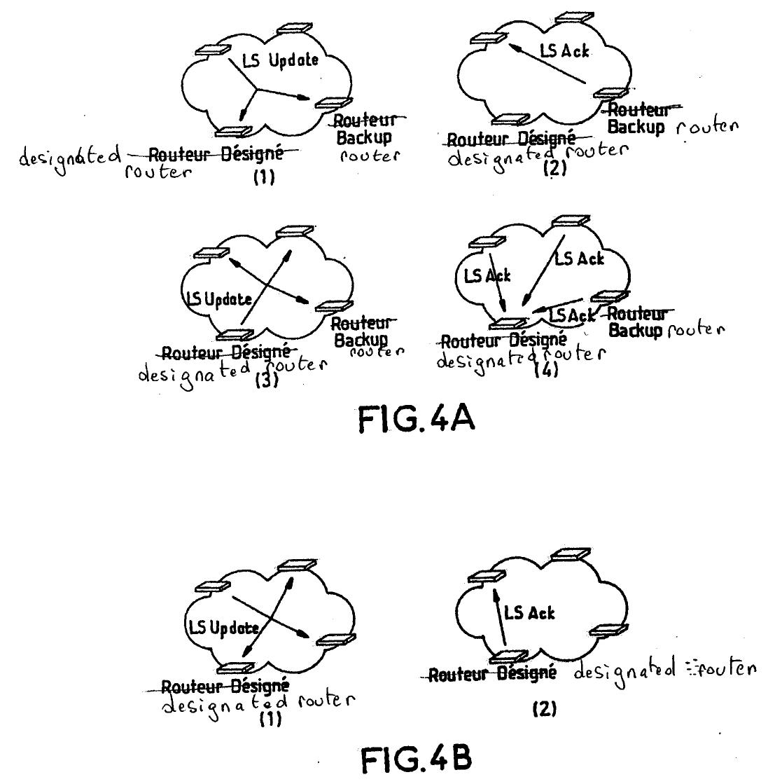

The flooding mechanism is obtained for example by sending Link State Update packets from one entity to the next, from router to router. Each packet may contain one or more LSAs. It has the advantage of decentralizing the dispatch of the packets and directly transmitting the information to all the routers of the network without going through the designated router. The working of this mechanism is shown in FIG. 4B, while FIG. 4A show the protocol commonly used in the case of the OSPF. It can be clearly seen in FIG. 4A that the designated router has a central role and, in FIG. 4B, that the mechanism is decentralized.

This mechanism can be made reliable in two phases described here below.

The flooding process is set up as soon as the router receives a Link State Update packet traveling from one entity to the next. The router travels through the different LSA contained in the message and installs the new ones and the most recent ones in its database. Depending on the type of LSA added or modified in the base, the router recomputes its routing table (full computation of the table in the case of the Router or Network LSA, computation of the inter-zone routes or inter-SA in the case of the Summary or AS-External LSA).

Each modification of the database, whether due to the reception of a Link State Update or the creation of an LSA by the router itself is, for example, transmitted on the different output interfaces of the router to synchronies the database of all the routers of the network. Each router keeps a list of the different LSAs that it must send on each interface.

The router chooses the output interfaces on which it may have to send an updating message and it examines these outputs one by one to find out if it is necessary to send this message or not. This set of output interfaces depends on the type of LSA to be broadcast:

AS-External LSAs: these must be broadcast throughout the SA. Thus, all the interfaces of the router have to be tested,

All the other LSAs: they must be broadcast only inside the zone for which they describe the links. Thus, all the interfaces belonging to the zone of the LSA will be tested.

Once the router has determined all the interfaces that it has to test, it executes the following algorithm on each of these interfaces:

if the interface is the message reception interface, then the method goes to the next interface,

if, on the interface, the synchronization phase is not yet terminated and if the LS Update message responding to that of the designated router has not been sent, then the operation passes to the next interface.

At this stage, the LSA must be transmitted on the link. A Link State Update containing the LSAs is sent to the interface. The age of the LSA must be implemented by the value of the estimated transmission time for the link. The designated router acknowledges all the LS Update messages by means of an LS Ack message. If the acknowledgement is not received after a Retransmission Interval, then the message is sent again.

These exchanges can be made reliable as follows:

by the acknowledgement of all the messages by the designated router associated with the retransmission of the non-acknowledged messages,

by the presence of a sequence number in all the LS Update messages.

The acknowledgement of all the messages by the designated router gives this router a permanent and consistent database. The term “consistent” refers to the fact that all the routers of a zone possess the same link state database in order to be able to compute the same routes. Each LSA is acknowledged separately by the designated router. The acknowledgements are contained in Link State Acknowledgment packets. Such a packet may furthermore contain several acknowledgments. This consistency of the database of the designated router ensures that the synchronization process will work optimally.

The presence of a sequence number in all the LS Update messages is used for example to enable the routers to detect the fact that a message has not reached them (message not acknowledged). This sequence number, which is proper to each router, is implemented each time that an LS Update message is sent in the network (except for message retransmission operations). Each router can then compare the contents of its table with that of the designated router. A router that possesses a sequence number lower than the number present in the message, sends an LS Request message to the designated router containing the list of lost messages. At reception of the LS Request message, the designated router will broadcast the messages requested by the request on the network, after a Request Interval.

The constants take for example, the following values:

| | VHF network | LAN |
|---|---|---|
| Hello Interval | 50 seconds | 10 seconds |
| Router Dead Interval | 200 seconds | 40 seconds |
| Retransmission Interval | 100 seconds | 5 seconds |
| Sequence Interval | 200 seconds | 40 seconds |
| Request Interval | 10 seconds | 2 seconds |

What is claimed is

1- A method for routing messages among several radio networks, a radio network comprising at least one or more routers and one designated router (RD), each router comprising a database, wherein the method comprises at least the following steps:
at the level of the majority of radio networks, each router sends a request Rr to the designated router (RD) of the radio network,
the designated router (RD) responds by sending the contents of its database to all or to the majority of the routers of the radio network,
a router of the radio networks, having received the contents of the database, sends a Hello message in order to search for its different neighbors,
each router, knowing its neighbors, sends all the other routers of the network the contents of its database in order to synchronize all its neighbors.

2- A method according to claim 1 wherein, after the step for synchronizing all the neighbors, the designated router broadcasts local information to the networks external to its own network.

3- A method according to claim 1 wherein the Hello message is broadcast periodically.

4- A method according to claim 1 wherein, after discovering its neighbors, a router sends an LS request message in unicast mode to the designated router, the message being repeated in the event of absence of a response after a given Retransmission Interval.

5- A method according to claim 4 wherein, the designated router having broadcast the contents of its database to all the routers of the network by sending an LS Update message, each router, upon the reception of the LS Update message, compares the information contained in the message with the contents of its database and sends an LS Update message in multicast mode, and the designated router acknowledges this message.

6- A method according to one of the claims 1 to 5 comprising the acknowledgment of all the messages by the designated router and the retransmission of the non-acknowledged messages and/or the presence of a sequence number in all the LS Update messages.

7- A method according to one of the claims 1 to 6 wherein the radio network is of the broadcasting network, NBMA network or again the multicast network type.
